(19) United States
(12) Patent Application Publication
(10) Pub. No.: US 2006/0177663 A1
(43) Pub. Date: Aug. 10, 2006

(54) Carbon-carbon composite article manufactured with needled fibers

(75) Inventors: Allen H. Simpson, Buchanan, MI (US); Slawomir T. Fryska, Granger, IN (US); Mark L. La Forest, Granger, IN (US); Mark C. James, South Bend, IN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/053,390

(22) Filed: Feb. 8, 2005

(51) Int. Cl. C01B 31/02; B32B 9/00

(52) U.S. Cl. 428/408; 264/29.5; 264/103; 264/29.1

(57) ABSTRACT

Method of making a carbon-carbon composite article such as an aircraft brake disc. The method includes: selecting carbon fiber precursors, having limited shrinkage in the axial direction when carbonized, in the form of individualized chopped or cut fibers; placing the selected chopped or cut carbon fiber precursors into a preform mold configured in the form of a brake disc to form a fibrous matrix; and then needling the molded fibrous matrix to provide it with three-dimensional structural integrity and to reduce layering. The carbon fiber precursor matrix may subsequently be infused with liquid carbon matrix precursor, the impregnated matrix may be carbonized; e.g., at 600-1800° C. for 1-10 hours to provide a preform having a density of at least about 1.1 g/cc, and the carbonized preform may be further densified to a density of at least about 1.6 g/cc by known liquid resin infiltration techniques and/or by conventional CVI/CVD processing.

### FIELD OF THE INVENTION

This invention relates to methods for the manufacture of carbon-carbon composite articles such as brake discs and preforms and to carbon-carbon composite articles manufactured by the disclosed methods. A particularly preferred embodiment of the present invention is a carbon-carbon composite disc made from pitch and needled thermoset pitch fiber. The method of the present invention is especially adapted for the manufacture of aircraft brake discs.

### BACKGROUND OF THE INVENTION

Carbon fibers for use as reinforcement in carbon-carbon composites are created from such precursors as polyacrylonitrile (PAN), pitch, and rayon fibers. PAN-based fibers offer good strength and modulus values and excellent compression strength for structural applications. Pitch fibers may be made from petroleum or coal tar pitch. Pitch fibers have extremely high modulus values and favorable coefficients of thermal expansion. Those skilled in the art know of many different ways to manufacture carbon-carbon composite materials.

U.S. Pat. No. 5,587,203 claims a method of making a carbon-carbon composite material by impregnating a carbon preform with a carbonaceous pitch having precisely defined characteristics and then heating the impregnated preform at 250-3000° C. while compressing it at a pressure higher than atmospheric pressure up to 10 kg/cc to carbonize the pitch and create a carbon-carbon composite preform. As disclosed in column 3 of the patent, the carbon preform is obtained by molding carbon fibers and/or raw materials for carbon fibers or by molding these fibers and carbon matrix precursor. As described in lines 28-32 of column 3 in the patent, the carbon fibers are obtained by the carbonization, at 1000-1500° C., or graphitization, at 2000-3000° C., of precursor fibers derived from pitch, polyacrylonitrile, or rayon. The raw materials for carbon fibers are precursors of the above-mentioned carbon fibers. Apparently these raw materials are infusibilized or stabilized before their incorporation into the preform. “The molded products of carbon fibers and/or raw materials for carbon fibers are referred to as two-dimensional or three-dimensional moldings made from fiber aggregates such as three-dimensional textiles, felts and mats.” Column 3, lines 42-45.

U.S. Pat. No. 5,614,134 claims a method of making a carbon-carbon composite preform by subjecting pitch-based infusibilized fibers to forcible charging, free falling, or uniform feeding treatment into a vessel and subjecting the deposited fibers to carbonization and molding treatment under uniaxial pressing.

U.S. Pat. No. 5,935,359 claims a method of making a carbon-carbon composite preform by fixing a laminate of stacked carbon fibers with a jig, impregnating the thus-fixed laminate with a molten carbonaceous pitch, and carbonizing the impregnated laminate at a rate of 1 C° /hour to 1000 C° /minute at ambient pressure or by isotactic pressing.

U.S. Pat. No. 5,993,905 claims a method of making a carbon-carbon composite preform by impregnating a plurality of carbonaceous fiber preforms with a solution containing colloidal carbon, drying the impregnated preforms, sewing the plurality of impregnated preforms together, and mechanically consolidating the plurality of impregnated preforms.

U.S. Pat. No. 6,093,482 claims a method of making a carbon-carbon composite preform by alternatively piling up layers of a mixture of carbon fibers, pitch powder, and graphite powder and layers of carbon fabrics, carbon-based prepregs, and segmented carbon-based prepregs, heating and pressing the preform within a mold to obtain a green body, carbonizing the green body to make a carbonized body, impregnating the carbonized body with pitch powder, recarbonizing the impregnated body, and subjecting the result impregnated and recarbonized body to chemical vapor infiltration.

U.S. Pat. No. 6,105,223 describes a method of making thick fibrous structures by a needle-felting process wherein loose fiber is accreted into a thick fibrous structure by repeatedly driving a multitude of felting needles into the loose fiber, the felting needles penetrating all the way through the fibrous material at the beginning of the process, and penetrating only part way through the fibrous material at the end of the process. As disclosed in column 10 of the '223 patent, the loose fiber is preferably disposed over the coherent fibrous structure just ahead of the felting needles.

U.S. Pat. No. 6,183,583 B1 claims a method of making a carbon-carbon composite preform by forming a three-dimensional fiber structure by super-posing layers of felt and needling them together, compressing the fiber structure to obtain a fiber preform, holding the preform in its compressed state by injecting a liquid bonding agent inside a tooling in which the preform is compressed, and densifying the preform.

U.S. Pat. No. 6,521,152 B1 teaches a process that includes depositing chopped fibrous materials and binder materials onto a belt conveyor and subsequently mixing them to provide a uniform dispersion of fibrous and binder materials in a mold. The uniformly mixed materials are heated and compacted in the mold to provide the desired shape of the fiber-reinforced composite part.

U.S. Pat. No. 6,699,427 B2 claims a method of making a carbon-carbon composite preform by combining a reinforcement material having carbon-containing fibers with a carbonizable matrix material and heating the mixture to melt at least some of the matrix material by applying an electric current to the mixture while applying a pressure of at least 35 kg/cc to the mixture.

U.S. Pat. No. 6,756,112 B1 claims a method of making a carbon-carbon composite preform by providing a fiber/matrix preform of desired shape, impregnating the preform with a polycyclic aromatic monomer such as anthracene, polymerizing the monomer in situ into a pre-carbon polymer of desired molecular weight, and pyrolyzing the pre-carbon polymer to form a carbon matrix material. The impregnation and polymerization steps are repeated to further densify the preform.

Carbon-carbon composite preforms for use in demanding applications such as aircraft brake parts are conventionally made from carbon fibers, which are expensive, or from carbon-fiber precursors, which are relatively inexpensive. However, when carbon-fiber precursors are used, it is necessary to carbonize them after making them into a preform and before densifying them. This adds significant cost to the finished composite material.

### SUMMARY OF THE INVENTION

The present invention provides methods of making carbon-carbon composite preforms and brake discs that differ from those currently known in terms of improved structural integrity, thermal conductivity, density, and ease of manufacture.

More specifically, the present invention provides a method of making a carbon-carbon composite brake disc preform. The method of the invention starts with the selection of carbon fiber precursors that have limited shrinkage in the axial direction when carbonized. Thermoset pitch fibers and oxidized polyacylonitrile fibers that have been partially carbonized are typical of such fibers. In a first step in this invention, all of the selected carbon fiber precursors are placed into a preform mold configured in the shape of a brake disc.

In the mold, the fibers are needled to provide them with three-dimensional structural integrity and to reduce layering. In accordance with the present invention, all of the fibers to be used are loaded into the mold and then needled until the percentage of fibers having an out-of-plane direction is between about 5% and 25%. In the process of this invention, the needles normally penetrate through the entire thickness of the preform being manufactured with every stroke.

Subsequent to needling, the carbon fiber precursor matrix is infused with a liquid carbon matrix precursor, such as molten pitch. A pitch that is particularly useful is Koppers Coal Tar Pitch having a softening point of 180° C. This step is normally conducted at a temperature between about 275° C. and 375° C. A gas pressure in the range 50-250 psi may be applied to the pitch while infusing the pitch into the preform to facilitate impregnation of the preform. After this resin impregnation, the impregnated matrix is carbonized, e.g. at 600-1800° C. for 1-10 hours at atmospheric pressure.

In accordance with the present invention, this provides a preform having a density of at least about 1.1 g/cc. The carbonized preform is subsequently densified to a density of at least about 1.6 g/cc, e.g. by liquid resin infiltration and/or by CVI/CVD processing.

Thus, one embodiment of the present invention is a method of making a carbon-carbon composite brake disc. This method includes: selecting carbon fiber precursors, having limited shrinkage in the axial direction when carbonized, in the form of individualized chopped or cut fibers; placing the selected chopped or cut carbon fiber precursors into a preform mold configured in the form of a brake disc to form a fibrous matrix; and compressing and needling the molded fibrous matrix to provide them with three-dimensional structural integrity and to reduce layering. Subsequently, the carbon fiber precursor matrix may be infused with liquid carbon matrix precursor, the impregnated matrix may be carbonized at 600-1800° C. for 1-10 hours to provide a preform having a density of at least about 1.1 g/cc, and the carbonized preform may be further densified to a density of at least about 1.6 g/cc by known liquid resin infiltration techniques and/or by conventional CVI/CVD processing.

In this embodiment of the invention, the carbon fibers are preferably thermoset pitch fibers or oxidized polyacylonitrile fibers that have been partially carbonized. Most preferably, they are thermoset pitch fibers or oxidized polyacrylonitrile fibers that have been carbonized at temperatures in the range 400° C. to 850° C. The fibers in the mold are preferably needled until the percentage of fibers with out-of-plane direction is between 5% and 25%, for instance approximately 10 weight-%. The fibers in the mold may be compressed while needling so that the needled preform has a fiber volume fraction of between 20% and 35%, for instance approximately 30%.

Also in this embodiment of the invention, the carbon fiber precursor matrix may infused with molten pitch, for example, with Koppers Coal Tar Pitch having a softening point of about 180° C. The impregnated matrix may then be carbonized at 750-1500° C. for 2-6 hours. For example, the impregnated matrix may be carbonized at about 750° C. for approximately 3 hours to provide a preform having a density of approximately 1.15 g/cc. Subsequently, the carbonized preform may be further densified to a density of at least about 1.7 g/cc by liquid resin infiltration and by CVI/CVD processing.

Another embodiment of the present invention is an aircraft landing system brake disc made by the method described herein. It is preferred that this brake disc has a density of approximately 1.7 g/cc. In some embodiments, the brake disc has a density of approximately 2.0 g/cc.

### DETAILED DESCRIPTION OF THE INVENTION

One illustrative embodiment of the present is a method of making a carbon-carbon composite preform, by the steps of: placing thermoset pitch carbon fiber precursors into a preform mold; needling the fibers in the mold until the percentage of fibers with out-of-plane direction is between 5% and 25%; and compressing the fibers in the mold while needling so that the needled preform has a fiber volume fraction of between 20% and 35%. This preform may be infused with molten Koppers Coal Tar Pitch while maintaining a temperature in the mold of 275° C.-375° C. One may apply a gas pressure of 50 psi-300 psi to the pitch while infusing the pitch into the preform to enhance impregnation of the preform. One may carbonize the resulting preform at a temperature of about 700° C. for approximately 2-5 hours. Various aspects and variations of this and related methods of the present invention are described below.

The present invention employs carbon fiber precursors selected to have minimal shrinkage in the axial direction when carbonized. Minimal shrinkage in the context of the present invention means less than 10% linear shrinkage. Examples of suitable fibers are thermoset pitch fibers and partially carbonized oxidized polyacrylonitrile fibers. Thermoset pitch fibers and partially carbonized oxidized polyacrylonitrile fibers suitable for use in the present invention may be obtained from a wide variety of sources such as e.g. Zoltek Corporation of St. Louis, Mo. and Cytec Industries Inc. of West Paterson, N.J.

In accordance with this invention, suitable loose, short, partially carbonized carbon fiber precursors (e.g., thermoset pitch fibers) are placed into a preform mold. Most planar preform articles made of loose fibers (such as those produced in the course of manufacturing brake discs) have nearly all of their fibers oriented generally parallel to the plane of the composite material. This adversely affects the structural integrity of the composite article. It also tends to slow the transfer of heat energy away from the surface of the composite article to the interior regions thereof. Carbon fibers as such are normally not used for this purpose, because the carbon fibers are too brittle to be needled without damaging the fibers. Preforms made of carbon fiber precursors, such as oxidized polyacrylonitrile fibers that are not partially carbonized as required by the present invention, tend to crack during the carbonization process because the fibers shrink in the axial direction after the matrix solidifies.

After the loose carbon fiber precursors are placed into the preform mold, the fibrous matrix is needled to provide the preform with a significant proportion of fibers that have out-of-plane orientation. When the needling process is complete, between 5% and 25% of the fibers in the preform will have out-of-plane orientation. This needling process provides the preform with three-dimensional structural integrity, reduces layering of the carbon fibers, and binds the fibers in the fibrous matrix together. The out-of-plane fibers provide the finished composite with superior thermal conductivity in the out-of-plane direction compared to similar materials made without needling. Also, the carbon fiber precursors are less brittle than carbon fibers as such, and so are less damaged by the needling process.

Once all of the fibers that will be used to make the preform are dumped into the mold, needling may begin without further treatment of the fibrous matrix. Optionally, however, the fibrous matrix may be compressed before and/or during the needling procedure. Compression prior to needling may be carried out by means of an annular compression plate situated on top of the fibrous matrix in the mold. Compression during needling may be carried out, for instance, by placing a perforated annular compression plate on top of the fibrous matrix in the mold. The needles are aligned with the holes in the plate to permit needling at the same time as compression. Compression may be carried out as described herein to provide a needled preform that has a fiber volume fraction of between 20% and 35%, e.g., approximately 30%.

Fiber reinforced composite materials may be produced by impregnating or depositing a matrix within the fibrous structures produced as described above. Thick fibrous structures used in fiber reinforced composite materials may be referred to as “preforms”. Various known processes may be employed, alone or in combination, to deposit a matrix within the fibrous structure. Such processes include, without limitation, resin impregnation, chemical vapor infiltration (CVI), chemical vapor deposition (CVD), resin or pitch impregnation with subsequent pyrolyzation, and infiltration of a precursor liquid with subsequent decomposition and deposition. Suitable processes and apparatuses for depositing a binding matrix within a porous structure are described, for instance, in U.S. Pat. No. 5,480,678, entitled “Apparatus for Use with CVI/CVD Processes”. The disclosure of U.S. Pat. No. 5,480,678 patent is incorporated by reference herein.

More specifically, for instance, after needling, the partially carbonized carbon-fiber precursor matrix is infiltrated with molten pitch or with other carbon matrix precursors such as phenolic resin. The impregnated matrix is carbonized, for instance at 600-1500° C. for about 3 hours. This results in a carbon-carbon composite preform having a density of approximately 1.25 grams per cubic centimeter. This preform may then be heat-treated to further open the porosity prior to additional densification. Alternatively, further densification may be carried out without heat treatment.

Whether the preform is heat-treated or not, for most applications the resulting preform is further densified. The densification processes that are used may be liquid phase resin densification followed by carbonization and/or densification may be accomplished by conventional CVI/CVD processes, as described above. Typically, combinations of these processes will be used until the carbon-carbon composite reaches a density in the range of 1.60 to 1.95 grams per cubic centimeter or even higher. At that time the composite may be heat-treated again to impart desirable physical properties to the composite material.

Those skilled in the art are well acquainted with the basic techniques that may be used to implement this particular invention. Among the prior art disclosures that discuss such techniques, in addition to U.S. Pat. No. 5,480,678 discussed above, are U.S. Pat. Nos. 5,587,203, 5,614,134, and 6,521,152 B1. The entire disclosure of each of U.S. Pat. No. 5,587,203, U.S. Pat. No. 5,614,134, and U.S. Pat. No. 6,521,152 B1 is incorporated by reference in the present application.

### EXAMPLES

### Comparative Example 1

A preform is manufactured with stabilized pitch fibers employing conventional processing procedures. The preform is needled to provide out-of-plane fibers and to bind loose fibers together. After carbonization at 900° C., the preform has a bulk density of 0.56 g/cc.

### Comparative Example 2

A preform is manufactured using carbonized fibers using conventional processing procedures. Needling is employed to create out-of-plane fibers. The resulting preform is of low quality because the needling breaks many of the carbon fibers. The fully densified composite part is of low strength and has low thermal conductivity due to the resulting very short fiber length.

### Comparative Example 3

A preform is manufactured by needling segments of oxidized polyacrylonitrile cloth together. The preform is similar to others currently in commercial production, which are carbonized before being densified by conventional CVI/CVD processing. The preform is infiltrated with molten Koppers Coal Tar Pitch having a softening point of 180° C. and then is carbonized to 1600° C. The resulting preform has a density of 1.2 g/cc. There are multiple cracks in the preform caused by axial direction shrinkage of the fiber that occurs after the pitch matrix has solidified during carbonization.

### Example 1

Chopped thermoset pitch fibers are placed into a brake disc mold. The preform is then needled to bind loose fibers together and to provide 10% by weight out-of-plane fibers. Prior to carbonization, the needled preform is infiltrated at 300° C. with Koppers Coal Tar Pitch. After carbonization at 900° C. for 2.5 hours, the preform has a bulk density of 1.1 g/cc. The preform is then densified by CVI/CVD processing to provide a brake disc having a density of 1.7 g/cc.

### Example 2

Chopped thermoset pitch fibers are placed into a brake disc mold. The preform is then compressed and needled to bind loose fibers together and to provide the preform with 20% by weight out-of-plane fibers and a fiber volume fraction of 30%. Prior to carbonization, the needled preform is infiltrated at 350° C. with Koppers Coal Tar Pitch. After carbonization at 1400° C. for 5 hours, the preform has a bulk density of 1.25 g/cc. The preform is then densified by RTM processing to provide a brake disc having a density of 1.9 g/cc.

### Example 3

Chopped partially carbonized oxidized polyacrylonitrile fibers are placed into a brake disc mold and stabilized therein using conventional processing procedures. The preform is then needled to bind loose fibers together and to provide 15% by weight out-of-plane fibers. Prior to carbonization, the needled preform is infiltrated at 325° C. with Koppers Coal Tar Pitch. After carbonization at 1000° C. for 3 hours, the preform has a bulk density of 1.2 g/cc. The preform is then densified by RTM processing and by CVI/CVD processing to provide a brake disc having a density of 1.7 g/cc.

What is claimed is:

1. A method of making a carbon-carbon composite brake disc, which method comprises the steps of:
selecting carbon fiber precursors, having limited shrinkage in the axial direction when carbonized, in the form of individualized chopped or cut fibers;
placing the selected chopped or cut carbon fiber precursors into a preform mold configured in the form of a brake disc to form a fibrous matrix;
needling the fibrous matrix in the mold to provide it with three-dimensional structural integrity and to reduce layering;
infusing the carbon fiber precursor matrix with liquid carbon matrix precursor;
carbonizing the impregnated matrix at 600-1800° C. for 1-10 hours, to provide a preform having a density of at least about 1.1 g/cc; and
further densifying the carbonized preform, to a density of at least about 1.6 g/cc, by liquid resin infiltration and/or by CVI/CVD processing.

2. The method of claim 1, wherein the carbon fibers selected are thermoset pitch fibers or oxidized polyacylonitrile fibers that have been partially carbonized.

3. The method of claim 2, wherein the carbon fibers selected are thermoset pitch fibers.

4. The method of claim 2, wherein the carbon fibers selected are oxidized polyacrylonitrile fibers that have been carbonized at temperatures in the range 400° C. to 850° C.

5. The method of claim 1, wherein the compressed fibers in the mold are needled until the percentage of fibers with out-of-plane direction is between 5% and 25%.

6. The method of claim 5, wherein the fibers in the mold are needled until the percentage of fibers with out-of-plane direction is approximately 10 weight-%.

7. The method of claim 1, wherein the fibers in the mold are compressed prior to or during needling to provide a needled preform that has a fiber volume fraction of between 20% and 35%.

8. The method of claim 7, wherein the fibers in the mold are compressed to provide a needled preform having a fiber volume fraction of approximately 30%.

9. The method of claim 1, wherein the carbon fiber precursor matrix is infused with molten pitch.

10. The method of claim 9, wherein the carbon fiber precursor matrix is infused with liquid matrix carbon precursor having a softening point of about 180° C.

11. The method of claim 1, wherein the impregnated matrix is carbonized at 750-1500° C. for 2-6 hours.

12. The method of claim 11, wherein the impregnated matrix is carbonized at about 750° C. for approximately 3 hours, to provide a preform having a density of approximately 1.15 g/cc.

13. The method of claim 1, wherein the carbonized preform is further densified to a density of at least about 1.7 g/cc by liquid resin infiltration and by CVI/CVD processing.

14. An aircraft brake disc made by the method of claim 1.

15. The brake disc of claim 14, having a density of approximately 1.7 g/cc.

16. The brake disc of claim 15, having a density of approximately 2.0 g/cc.

17. A method of making a carbon-carbon composite preform, which method comprises the steps of:
placing thermoset pitch carbon fiber precursors into a preform mold;
needling the fibers in the mold until the percentage of fibers with out-of-plane direction is between 5% and 25%;
infusing the preform with liquid matrix carbon precursor while maintaining a temperature in the mold of 275° C.-375° C.; and
carbonizing said preform at a temperature of about 700° C. for approximately 2-5 hours.

18. The method of claim 17, which comprises compressing the fibers in the mold prior to needling so that the needled preform has a fiber volume fraction of between 20% and 35%.

19. The method of claim 17, wherein a gas pressure of 50 psi-300 psi is applied to the pitch while infusing the pitch into the preform in order to enhance impregnation of the preform.
